(19) United States
(12) Patent Application Publication
(10) Pub. No.: US 2023/0338993 A1
(43) Pub. Date: Oct. 26, 2023

(54) APPARATUS FOR HEATING CHEMICAL LIQUID AND SYSTEM FOR TREATING SUBSTRATE INCLUDING THE SAME

(71) Applicant: SEMES CO., LTD., Chungcheongnam-do (KR)

(72) Inventors: Yoon Ki SA, Gyeonggi-do (KR); Do Yeon KIM, Gyeonggi-do (KR); Pil Kyun HEO, Gyeonggi-do (KR)

(21) Appl. No.: 17/727,659

(22) Filed: Apr. 22, 2022

(51) Int. Cl. B08B 3/10; B08B 3/02

(52) U.S. Cl. CPC B08B 3/10; B08B 3/02; B08B 2203/007

(57) ABSTRACT

There are provided an apparatus for heating a chemical liquid that heats a chemical liquid using a heating element with a light source as a medium, and a system for treating a substrate with the apparatus. The apparatus for heating a chemical liquid includes: a flow path provided as a path through which a chemical liquid used to treat a substrate passes; a heating element disposed to surround at least a portion of the flow path; and a light source irradiating the heating element with light, wherein the heating element is heated using photon excitation, and heats the chemical liquid.

### BACKGROUND

### 1. Technical Field

The present disclosure relates to an apparatus for heating a chemical liquid and a system for treating a substrate with the apparatus. More particularly, the present disclosure relates to an apparatus for heating a chemical liquid capable of being applied to cleaning of a substrate and a system for treating a substrate with the apparatus.

### 2. Description of the Related Art

A process of fabricating a semiconductor device may be continuously performed within a semiconductor fabrication facility, and may be divided into a pre-process and a post-process. The semiconductor fabrication facility may be generally installed in a space defined as a FAB in order to fabricate the semiconductor device.

The pre-process refers to a process of forming circuit patterns on a wafer to complete chips. The pre-process may include a deposition process of forming a thin film on the wafer, a photolithography process of transferring a photoresist onto the thin film using a photomask, an etching process of selectively removing unnecessary portions using a chemical substance or a reactive gas in order to form desired circuit patterns on the wafer, an ashing process of removing the photoresist remaining after the etching process, an ion implantation process of implanting ions into portions connected to the circuit patterns to impart characteristics of an electronic device, a cleaning process of removing a contamination source on the wafer, and the like.

The post-process refers to a process of evaluating performance of a product completed through the pre-process. The post-process may include a wafer inspection process of inspecting whether or not each chip on the wafer operates to sort good and bad products, a package process of cutting and separating each chip through dicing, die bonding, wire bonding, molding, marking, etc., to form a shape of a product, a final inspection process of finally inspecting characteristics and reliability of the product through electrical characteristic inspection, burn-in inspection, etc., and the like.

When a FAB process is performed to cause a change in appearance of a wafer, chemical/physical residues are left on the wafer surface, and a process of removing such residues is a cleaning process.

The cleaning process may be roughly divided into three types, which correspond to wet cleaning using a chemical solution, dry cleaning using a medium other than a solution, and vapor cleaning using a vapor, which is an intermediate type of the wet cleaning and the dry cleaning.

In a case of the wet cleaning, a substrate may be cleaned using a chemical liquid such as isopropyl alcohol (IPA) or deionized (DI) water. In this case, the chemical liquid may be used to clean the substrate after being heated. However, conventionally, there is a problem that a yield is decreased due to an increase in particles in the cleaning process because the chemical liquid is heated using a resistor.

### SUMMARY

Aspects of the present disclosure provide an apparatus for heating a chemical liquid that heats a chemical liquid using a heating element with a light source as a medium, and a system for treating a substrate with the apparatus.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, an apparatus for heating a chemical liquid includes: a flow path provided as a path through which a chemical liquid used to treat a substrate passes; a heating element disposed to surround at least a portion of the flow path; and a light source irradiating the heating element with light, wherein the heating element is heated using photon excitation, and heats the chemical liquid.

The apparatus for heating a chemical liquid may further include a cover member covering the heating element.

The cover member may transmit the light.

The cover member may be made of quartz.

A temperature of the heating element may rise to a predetermined temperature before the chemical liquid passes through the flow path.

The heating element may be made of a material that does not react with the chemical liquid.

The heating element may be made of single-crystal silicon.

The heating element may be made of at least one of silicon (Si), silicon carbide (SiC), silicon dioxide (SiO₂), and aluminum nitride (AlN).

The heating element may have any one of a cross shape and a ring shape in a width direction.

The apparatus for heating a chemical liquid may further include a temperature sensor connected to an outlet of the flow path to measure a temperature of the chemical liquid, wherein it is confirmed whether a temperature of the heating element has risen based on the measured temperature of the chemical liquid.

The light source may include at least one of a light emitting diode (LED) source or a laser diode (LD) source.

The apparatus for heating a chemical liquid may further include a sidewall member disposed to surround the remaining portion of the flow path when the heating element is disposed to surround a portion of the flow path.

The sidewall member may be made of a material that does not react with the chemical liquid.

According to another aspect of the present disclosure, an apparatus for heating a chemical liquid includes: a flow path provided as a path through which a chemical liquid used to treat a substrate passes; a heating element disposed to surround at least a portion of the flow path; a light source irradiating the heating element with light; and a cover member covering the heating element and transmitting the light, wherein the heating element is heated using photon excitation, and heats the chemical liquid.

According to still another aspect of the present disclosure, a system for treating a substrate includes: an apparatus for storing a chemical liquid that stores the chemical liquid used to treat the substrate; a jetting member jetting the chemical liquid onto the substrate to allow the substrate to be treated; and an apparatus for heating a chemical liquid installed on a path through which the chemical liquid moves from the apparatus for storing a chemical liquid to the jetting member, wherein the apparatus for heating a chemical liquid includes: a flow path provided as a path through which the chemical liquid passes; a heating element disposed to surround at least a portion of the flow path; and a light source irradiating the heating element with light, the heating element being heated using photon excitation, and heating the chemical liquid.

Detailed contents of other exemplary embodiments are described in a detailed description and are illustrated in the drawings.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic cross-sectional view illustrating an internal structure of a system for treating a substrate according to an exemplary embodiment of the present disclosure;

FIG. 2 is a diagram illustrating a connection relationship between an apparatus for storing a chemical liquid, an apparatus for heating a chemical liquid, and a jetting member that constitute the system for treating a substrate according to an exemplary embodiment of the present disclosure;

FIG. 3 is a cross-sectional view illustrating an internal structure of the apparatus for heating a chemical liquid constituting the system for treating a substrate according to an exemplary embodiment of the present disclosure;

FIG. 4 is a plan view illustrating the internal structure of the apparatus for heating a chemical liquid constituting the system for treating a substrate according to an exemplary embodiment of the present disclosure;

FIG. 5 is an illustrative view for describing various arrangement structures of a light source constituting the apparatus for heating a chemical liquid illustrated in FIGS. 3 and 4;

FIG. 6 is a first illustrative view for describing various shapes of a heating element constituting the apparatus for heating a chemical liquid illustrated in FIGS. 3 and 4;

FIG. 7 is a second illustrative view for describing various shapes of a heating element constituting the apparatus for heating a chemical liquid illustrated in FIGS. 3 and 4;

FIG. 8 is a view illustrating a first test setup structure for evaluating performance of the apparatus for heating a chemical liquid constituting the system for treating a substrate according to an exemplary embodiment of the present disclosure;

FIG. 9 is a view illustrating a second test setup structure for evaluating performance of the apparatus for heating a chemical liquid constituting the system for treating a substrate according to an exemplary embodiment of the present disclosure;

FIG. 10 is a graphs of a first test result illustrating performance of the apparatus for heating a chemical liquid constituting the system for treating a substrate according to an exemplary embodiment of the present disclosure; and

FIG. 11 is a graph of a second test result illustrating performance of the apparatus for heating a chemical liquid constituting the system for treating a substrate according to an exemplary embodiment of the present disclosure.

### DETAILED DESCRIPTION OF THE EMBODIMENTS

Hereinafter, exemplary embodiments of the present disclosure will be described in detail with reference to the accompanying drawings. Various advantages and features of the present disclosure and a method accomplishing them will become apparent with reference to exemplary embodiments to be described later in detail in conjunction with the accompanying drawings. However, the present disclosure is not limited to exemplary embodiments to be disclosed below, but may be implemented in various different forms, these exemplary embodiments will be provided only in order to make the present disclosure complete and allow one of ordinary skill in the art to completely recognize the scope of the present disclosure, and the present disclosure will be defined by the scope of the claims. Throughout the specification, the same components will be denoted by the same reference numerals.

A phrase “one element or layer ‘on’ another element or layer” includes both of a case where one element or layer is directly on another element or layer and a case where one element or layer is on another element or layer with the other layer or element interposed therebetween. On the other hand, a phrase “one element or layer is ‘directly on’ another element or layer” indicates that the other element or layer is not interposed between one element or layer and another element or layer.

The spatially relative terms ‘below’, ‘beneath’, ‘lower’, ‘above’, ‘upper’, and the like, may be used in order to easily describe correlations between one element or component and other elements or components as illustrated in the drawings. The spatially relative terms are to be understood as terms including different directions of elements at the time of being used or at the time of operating in addition to directions illustrated in the drawings. For example, when elements illustrated in the drawings are overturned, an element described as ‘below or beneath’ another element may be put ‘above’ another element. Accordingly, an illustrative term “below” may encompass both of directions of above and below. Elements may be oriented in other directions as well, and accordingly, spatially relative terms may be interpreted according to orientations.

The terms ‘first’, ‘second’, and the like are used to describe various elements, components, and/or sections, but these elements, components, and/or sections are not limited by these terms. These terms are used only in order to distinguish one element, component, or section from another element, component or section. Accordingly, a first element, a first component, or a first section to be mentioned below may also be a second element, a second component, or a second section within the technical spirit of the present disclosure.

The terms used herein are for describing exemplary embodiments rather than limiting the present disclosure. In the present specification, a singular form includes a plural form unless stated otherwise in the phrase. Components, steps, operations, and/or elements mentioned by the terms “comprise” and/or “comprising” used herein do not exclude the existence or addition of one or more other components, steps, operations, and/or elements.

Unless defined otherwise, all the terms (including technical and scientific terms) used herein have the same meaning as meanings commonly understood by one of ordinary skill in the art to which the present disclosure pertains. In addition, the terms defined in generally used dictionaries are not ideally or excessively interpreted unless they are specifically defined clearly.

Hereinafter, exemplary embodiments of the present disclosure will be described in detail with reference to the accompanying drawings. In describing exemplary embodiments of the present disclosure with reference to the accompanying drawings, components that are the same as or correspond to each other will be denoted by the same reference numerals, and an overlapping description thereof will be omitted.

The present disclosure relates to an apparatus for heating a chemical liquid that heats a chemical liquid using a heating element with a light source as a medium, and a system for treating a substrate with the apparatus. Specifically, in the present exemplary embodiment, the apparatus for heating a chemical liquid may be implemented as a high-clean chemical liquid heater that uses a photon excitation method. Hereinafter, the present disclosure will be described in detail with reference to drawings and the like.

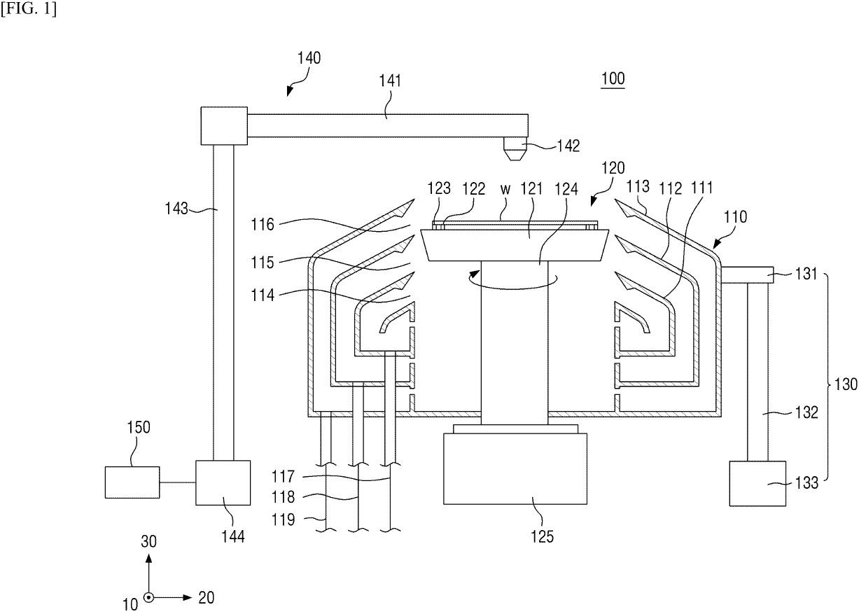

FIG. 1 is a schematic cross-sectional view illustrating an internal structure of a system for treating a substrate according to an exemplary embodiment of the present disclosure.

A system 100 for treating a substrate performs wet cleaning on a substrate. The system 100 for treating a substrate may clean the substrate using, for example, a chemical liquid. The system 100 for treating a substrate may be provided in a process chamber within a semiconductor fabrication facility.

The system 100 for treating a substrate may include, for example, a cup 110, a support member 120, an elevating unit 130, a jetting member 140, and a controller 150 when it cleans the substrate using the chemical liquid.

The cup 110 provides a space in which a process of treating a substrate W is performed. The cup 110 may be formed so that an upper portion thereof is opened.

The cup 110 may include an internal recovery container 111, an intermediate recovery container 112, and an external recovery container 113. In this case, the respective recovery containers 111, 112, and 113 may recover different treatment liquids of treatment liquids used in the process.

The internal recovery container 111 may be provided in the shape of an annular ring surrounding the support member 120. In this case, an internal space 114 of the internal recovery container 111 may function as an inlet through which the treatment liquid is introduced into the internal recovery container 111.

The intermediate recovery container 112 may be provided in the shape of an annular ring surrounding the internal recovery container 111. In this case, a space 115 between the internal recovery container 111 and the intermediate recovery container 112 may function as an inlet through which the treatment liquid is introduced into the intermediate recovery container 112.

The external recovery container 113 may be provided in the shape of an annular ring surrounding the intermediate recovery container 112. In this case, a space 116 between the intermediate recovery container 112 and the external recovery container 113 may function as an inlet through which the treatment liquid is introduced into the external recovery container 113.

The respective recovery containers 111, 112, and 113 may be connected to recovery lines 117, 118, and 119 vertically extending from bottom surfaces thereof in a downward direction, respectively. The respective recovery lines 117, 118, and 119 may discharge the treatment liquids introduced through the respective recovery containers 111, 112, and 113 to the outside. The treatment liquids discharged to the outside may be treated to be reused through a treatment liquid regeneration system (not illustrated).

The support member 120 supports the substrate W and rotates the substrate W during the process. The support member 120 may be disposed inside the cup 110.

The support member 120 may include a body 121, support pins 122, guide pins 123, and a first support shaft 124.

The body 121 may have a top surface provided in a substantially circular shape when viewed from above. The first support shaft 124 that may be rotated by a motor 125 may be fixedly coupled to a bottom surface of such a body 121. Meanwhile, a back nozzle (not illustrated) may be installed on the top surface of the body 121.

The support pins 122 support a bottom surface of the substrate W on the body 121. A plurality of such support pins 122 may be provided on the body 121.

The plurality of support pins 122 may be formed to protrude from the top surface of the body 121 in an upward direction. In addition, the plurality of support pins 122 may be disposed to be spaced apart from each other at predetermined intervals on an edge of the top surface of the body 121. The plurality of support pins 122 may be disposed to have, for example, an annular ring shape as a whole by a combination therebetween. The plurality of support pins 122 may support an edge of a rear surface of the substrate W so that the substrate W is spaced apart from the top surface of the body 121 by a predetermined distance through such a configuration.

The guide pins 123 are also referred to as chuck pins, and support side portions of the substrate W so that the substrate W is not separated from a regular position in a lateral direction when the support member 120 rotates. A plurality of such guide pins 123 may be provided on the body 121, similar to the support pins 122, and may be formed to protrude from the top surface of the body 121 in the upward direction.

The guide pins 123 may be disposed farther from the center of the body 121 than the support pins 122 are. The guide pins 123 may be provided to be linearly movable between a standby position and a support position along a radial direction of the body 121. Here, the standby position refers to a position farther from the center of the body 121 than the support position is.

The guide pins 123 may be positioned at the standby position when the substrate W is loaded to or unloaded from the support member 120, and may be positioned at the support position when the process is performed on the substrate W. The guide pins 123 may be in contact with the side portions of the substrate W at the support position.

The elevating unit 130 linearly moves the cup 110 in an up and down direction. As the cup 110 linearly moves in the up and down direction, a relative height of the cup 110 with respect to the support member 120 may be changed.

The elevating unit 130 may include a bracket 131, a moving shaft 132, and a first actuator 133.

The bracket 131 is to be fixedly installed on an outer wall of the cup 110. The bracket 131 may be coupled to the moving shaft 132 moved in the up and down direction by the first actuator 133.

When the substrate W is put on or lifted from the support member 120, the cup 110 may be lowered so that the support member 120 protrudes above the cup 110. In addition, when the process is performed, a height of the cup 110 may be adjusted so that the treatment liquid may be introduced into a preset recovery container 111, 112, or 113 according to a type of the treatment liquid supplied to the substrate W.

For example, while the substrate W is treated with a first treatment liquid, the substrate W may be positioned at a height corresponding to the internal space 114 of the internal recovery container 111. In addition, while the substrate W is treated with a second treatment liquid, the substrate W may be positioned at a height corresponding to the space 115 between the internal recovery container 111 and the intermediate recovery container 112. In addition, while the substrate W is treated with a third treatment liquid, the substrate W may be positioned at a height corresponding to the space 116 between the intermediate recovery container 112 and the external recovery container 113.

Meanwhile, the elevating unit 130 may move the support member 120 in the up and down direction, instead of the cup 110.

The jetting member 140 supplies the treatment liquid to the substrate W in the process of treating the substrate. To this end, the jetting member 140 may include a nozzle support 141, a nozzle 142, a second support shaft 143, and a second actuator 144.

One jetting member or a plurality of jetting members 140 may be provided. When the plurality of jetting members 140 are provided, a chemical liquid, a rinse liquid, an organic solvent, and the like, may be provided through different jetting members 140. The rinse liquid may be a first fluid, and the organic solvent may be a mixture of an isopropyl alcohol vapor and an inert gas, or an isopropyl alcohol liquid.

A longitudinal direction of the nozzle support 141 may be provided along a second direction 20. The nozzle support 141 may be coupled to one end portion of the second support shaft 143 in a direction perpendicular to a longitudinal direction of the second support shaft 143. The second actuator 144 may be coupled to the other end portion of the second support shaft 143.

The nozzle 142 may be installed on a bottom surface of a distal end of the nozzle support 141. Such a nozzle 142 may be moved to a process position and a standby position by the second actuator 144. Here, the process position refers to a zone above the support member 120 in a vertical direction, allowing the nozzle 142 to discharge the treatment liquid onto the substrate W, and the standby position refers to a zone excluding the zone above the support member 120 in the vertical direction, that is, a zone outside the zone above the support member 120 in the vertical direction.

A longitudinal direction of the second support shaft 143 may be provided along a third direction 30. Such a second support shaft 143 may be coupled to the second actuator 144 at a lower end thereof.

The second actuator 144 rotates and elevates the second support shaft 143. Such a second actuator 144 may be connected to and controlled by the controller 150.

Meanwhile, it has been illustrated in FIG. 1 that the controller 150 is connected to the second actuator 144. However, the present exemplary embodiment is not limited thereto. The controller 150 may also be connected to the first actuator 133 as well as the second actuator 144 to control the first actuator 133.

The jetting member 140 may be connected to an apparatus 210 for storing a chemical liquid in order to provide the chemical liquid onto the substrate W.

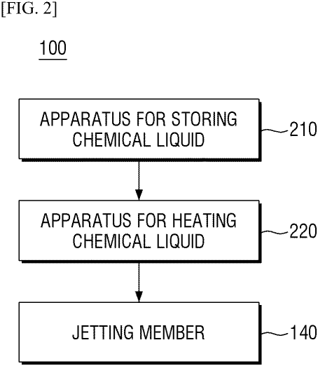

FIG. 2 is a diagram illustrating a connection relationship between an apparatus for storing a chemical liquid, an apparatus for heating a chemical liquid, and a jetting member that constitute the system for treating a substrate according to an exemplary embodiment of the present disclosure. The following description will be provided with reference to FIG. 2.

The apparatus 210 for storing a chemical liquid stores a chemical liquid (e.g., isopropyl alcohol (IPA), an organic solvent, etc.) used to clean the substrate W. The apparatus 210 for storing a chemical liquid may be connected to the jetting member 140 through a pipe having a predetermined length in order to supply the chemical liquid to the jetting member 140.

An apparatus 220 for heating a chemical liquid heats the chemical liquid. The apparatus 220 for heating a chemical liquid may heat the chemical liquid moving from the apparatus 210 for storing a chemical liquid to the jetting member 140. To this end, the apparatus 220 for heating a chemical liquid may be installed on a pipe connecting the apparatus 210 for storing a chemical liquid and the jetting member 140 to each other.

The apparatus 220 for heating a chemical liquid may heat the chemical liquid using a photon excitation method. Through this, the apparatus 220 for heating a chemical liquid may be implemented as a high-clean chemical liquid heater. Hereinafter, a structure of the apparatus 220 for heating a chemical liquid will be described in detail.

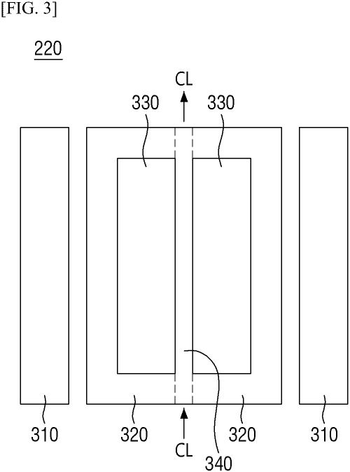

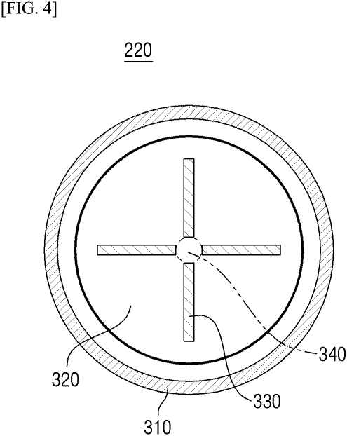

FIG. 3 is a cross-sectional view illustrating an internal structure of the apparatus for heating a chemical liquid constituting the system for treating a substrate according to an exemplary embodiment of the present disclosure, and FIG. 4 is a plan view illustrating the internal structure of the apparatus for heating a chemical liquid constituting the system for treating a substrate according to an exemplary embodiment of the present disclosure.

Referring to FIGS. 3 and 4, the apparatus 220 for heating a chemical liquid may include a light source 310, a cover member 320, and a heating element 330.

The light source 310 irradiates light. The light source 310 may be disposed around the heating element 330 and radiate light toward the heating element 330.

The heating element 330 may be inserted into the cover member 320. The light source 310 may be disposed to surround the entirety of an outer side of the cover member 320 in consideration of such a structure. In this case, the light source 310 may be disposed so as not to be in contact with the outer side of the cover member 320.

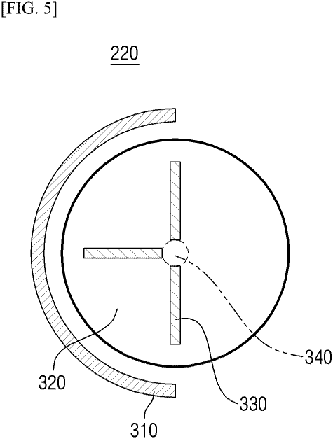

However, the present exemplary embodiment is not limited thereto. The light source 310 may also be disposed to surround only a portion of the outer side of the cover member 320, as illustrated in FIG. 5. In this case, the light source 310 may be disposed to surround a portion of the outer side of the cover member 320 in consideration of a position of the heating element 330 in the cover member 320. FIG. 5 is an illustrative view for describing various arrangement structures of a light source constituting the apparatus for heating a chemical liquid illustrated in FIGS. 3 and 4.

A description will be provided again with reference to FIGS. 3 and 4.

The light source 310 may be implemented as a light emitting diode (LED) source or a laser diode (LD) source in order to irradiate the heating element 330 with light. In the present exemplary embodiment, the light source 310 may be implemented as any source as long as it may heat the heating element 330 by irradiating to the heating element 330 with the light. For example, the light source 310 may also be implemented as an ultraviolet (UV) source or a halogen lamp.

The cover member 320 is to provide a movement path of a chemical liquid CL. To this end, the cover member 320 may have a flow path 340 penetrating through an inner portion thereof.

The cover member 320 may embed the heating element 330 heated by the light source 310. In this case, the heating element 330 may be embedded in the cover member 320 so as to surround the flow path 340 through which the chemical liquid CL moves.

The cover member 320 may be made of a material that may transmit light so that the light irradiated by the light source 310 may reach the heating element 330. For example, the cover member 320 may be made of quartz.

The heating element 330 is heated using the light irradiated by the light source 310. When the chemical liquid CL moves through the flow path 340, the heating element 330 may transfer thermal energy generated by the heating to the chemical liquid CL.

The heating element 330 may be embedded in the cover member 320 as described above. In this case, the apparatus 220 for heating a chemical liquid may not include the cover member 320 as long as the flow path 340 may be provided by the heating element 330 (for example, as long as the heating element 330 is formed to surround the flow path 340).

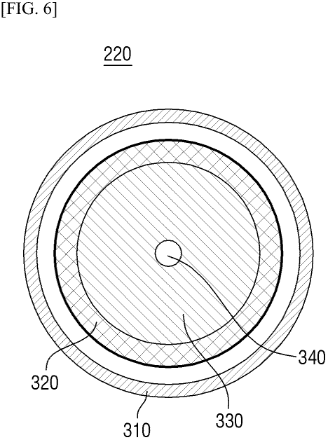

The heating element 330 may be inserted into the cover member 320 in a cross shape when viewed from above (Top-View). However, the present exemplary embodiment is not limited thereto. The heating element 330 may be formed in any shape as long as it may be installed close to the flow path 340 in order to transfer the thermal energy to the chemical liquid CL. The heating element 330 may be inserted into the cover member 320 in a ring shape when viewed from above, for example, as illustrated in FIG. 6. FIG. 6 is a first illustrative view for describing various shapes of a heating element constituting the apparatus for heating a chemical liquid illustrated in FIGS. 3 and 4.

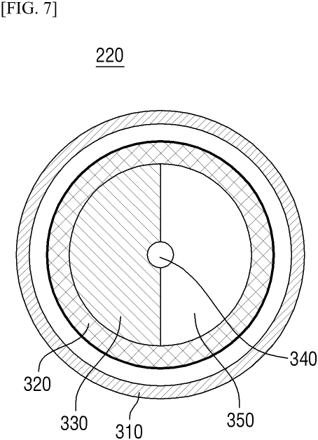

The heating element 330 may be formed to surround the entirety of the flow path 340 within the cover member 320. However, the present exemplary embodiment is not limited thereto. The heating element 330 may be formed to surround a portion of the flow path 340 within the cover member 320 as illustrated in FIG. 7. In this case, a sidewall member 350 covering the remaining portion of the flow path 340 may be added in the cover member 320. The sidewall member 350 may be made of a material that does not react with the chemical liquid CL. FIG. 7 is a second illustrative view for describing various shapes of a heating element constituting the apparatus for heating a chemical liquid illustrated in FIGS. 3 and 4.

The heating element 330 may be made of a material that may absorb the light in order to be heated using the light irradiated by the light source 310. In addition, the heating element 330 may be made of a material that does not react with the chemical liquid CL. When the heating element 330 is made of the material that may absorb the light and does not react with the chemical liquid CL, an effect of efficiently heating the chemical liquid CL without generating particles may be obtained.

The heating element 330 may be made of a silicon (Si) component in order to obtain the effect as described above. For example, the heating element 330 may be made of single-crystal silicon or may be made of a component such as silicon carbide (SiC) or silicon dioxide (SiO₂). However, the present exemplary embodiment is not limited thereto. The heating element 330 may also be made of an aluminum nitride (AlN) component.

When the heating element 330 is made of the silicon component, the heating element 330 may be provided as a mechanism in which heat is generated by intensity of Si. In the present exemplary embodiment, a temperature of the heating element 330 may rise to a reference temperature in advance before the chemical liquid passes through the flow path 340.

Meanwhile, since the heating element 330 is heated using the light irradiated by the light source 310, an effect that it becomes possible to use the heating element 330 itself as a permanent heating element may also be obtained.

Meanwhile, when a temperature of the chemical liquid CL is measured in order to confirm whether or not the temperature of the heating element 330 has risen, a temperature sensor may be connected to an outlet of the flow path 340 to measure the temperature of the chemical liquid CL.

The apparatus 220 for heating a chemical liquid may be implemented as an immersion-type heater heating the chemical liquid CL using a photon absorption-induced heating element 330 according to the photon excitation method, as described above. The apparatus 220 for heating a chemical liquid may fundamentally block a particle source through such a structure, and accordingly, may obtain an effect of increasing semiconductor fabrication efficiency. In addition, the apparatus 220 for heating a chemical liquid may be implemented as a high-efficiency and high-reliability heater having excellent stability and low loss of thermal conductivity or the like because there is no generation of latent heat due to a heating method by light emission.

A conventional apparatus for heating a chemical liquid may heat the chemical liquid using a resistor. In such a conventional apparatus for heating a chemical liquid, a Teflon component is coated on a heat element made of a nickel-chromium (Ni-Cr) alloy (Teflon-Coated Ni-Cr) in order to block generation of metal particles.

However, in the conventional apparatus for heating a chemical liquid, the Teflon material (PTFE) coated on the heat element may elute particles at a high temperature. In addition, an O-ring is applied to a liquid contact part such as PFA (tube), PTFE, and O-Ring (Viton + FEP), such that a particle source may be provided. Accordingly, in the conventional apparatus for heating a chemical liquid, a yield may decrease due to an increase in particles when the substrate is cleaned using a chemical liquid such as isopropyl alcohol (IPA) or deionized (DI) water.

The apparatus 220 for heating a chemical liquid according to the present exemplary embodiment may heat Si by irradiating Si with the light from the LED source, the LD source, or the like to generate heat by photon absorption, as described with reference to FIGS. 3 to 7. The apparatus 220 for heating a chemical liquid may apply single crystal Si that does not react with the chemical liquid (e.g., IPA) as a heat source, and latent heat is not generated when an LED is turned off, such that IPA vaporization and explosion-proof risks may also be minimized.

In addition, in the apparatus 220 for heating a chemical liquid according to the present exemplary embodiment, a liquid contact part may be composed of PFA, the cover member 320 (e.g., Quartz), the heating element 330 (e.g., Si), and the like, and accordingly, the O-ring, PTFE, and the like, providing the particle source may be removed from the liquid contact part.

In addition, the apparatus 220 for heating a chemical liquid may also obtain an effect of maintaining light transmittance while removing the particle source by applying a chemical bath made of quartz.

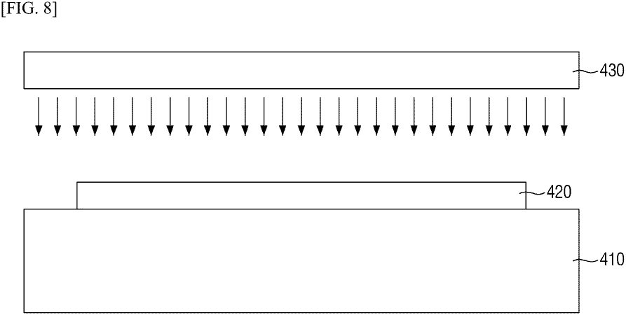

FIG. 8 is a view illustrating a first test setup structure for evaluating performance of the apparatus for heating a chemical liquid constituting the system for treating a substrate according to an exemplary embodiment of the present disclosure.

In order to evaluate validity of the apparatus 220 for heating a chemical liquid according to the present exemplary embodiment through a chemical liquid temperature rise test, a heating element (Si wafer) 420 was disposed on a glass substrate (glass) 410, and the heating element 420 was heated using a light source (LED array) 430 disposed above the heating element 420.

A Ø300 glass bath having a thickness (t) of 7 mm was used as the glass substrate 410, and a Ø200 Si wafer was used as the heating element 420. In addition, a Ø300 LED array heater was used as the light source 430.

Other test conditions are as follows.
Distance between heating element 420 and light source 430: 30 mm
Used chemical liquid: Water 3 L
Heating time: 5 to 10 minutes

After the heating time has elapsed, a temperature was measured for an upper surface of the heating element 420. As a test result, a temperature of the upper surface of the heating element 420 rose by about 50° C. in 5 minutes, and rose to about 75° C. after 9 minutes on the basis of the surface. When evaluation is performed using IPA as a chemical liquid, a temperature of the heating element 420 may be expected to faster rise.

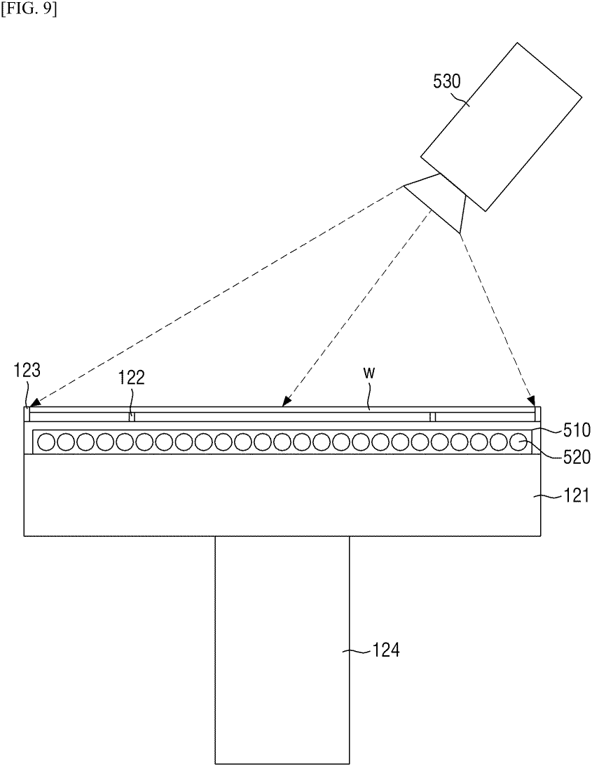

FIG. 9 is a view illustrating a second test setup structure for evaluating performance of the apparatus for heating a chemical liquid constituting the system for treating a substrate according to an exemplary embodiment of the present disclosure.

According to the test setup structure illustrated in FIG. 9, an Si temperature rise using an LED heater was evaluated. A plurality of LEDs 520 were disposed as light sources on a body 121 (e.g., a chuck), and a cover-type quartz window 510 was configured on the plurality of LEDs 520 so as to cover the plurality of LEDs 520. In addition, a substrate W was configured to be positioned on the quartz window using support pins 122 and guide pins 123.

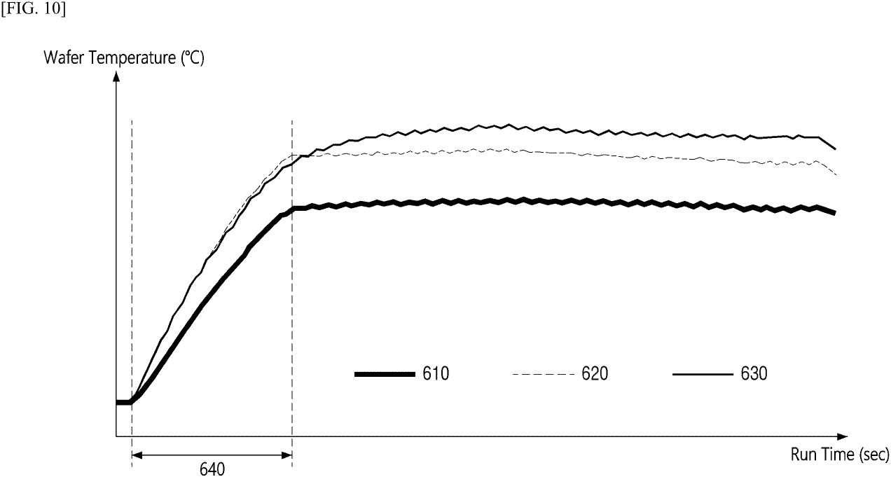

When a temperature of a surface of the substrate W was measured using a thermal imaging camera 530 according to the test setup structure illustrated in FIG. 9, it might be confirmed that the temperature rose to a predetermined temperature in respective zones (1 Point 610, 2 Point 620, and 3 Point 630) of the substrate W after a rising time 640 has elapsed, as illustrated in FIG. 10. FIG. 10 is a graphs of a first test result illustrating performance of the apparatus for heating a chemical liquid constituting the system for treating a substrate according to an exemplary embodiment of the present disclosure. Here, 1 Point 610 refers to one point in a center zone of the substrate W, 2 Point 620 refers to one point in a middle zone of the substrate W, and 3 Point 630 refers to one point in an edge zone of the substrate W.

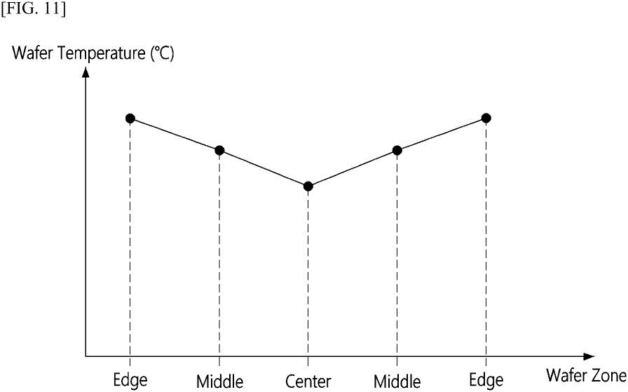

Meanwhile, it might also be confirmed from the above test that the temperature could be controlled with a V-shaped recipe between a center and an edge, as illustrated in FIG. 11. FIG. 11 is a graph of a second test result illustrating performance of the apparatus for heating a chemical liquid constituting the system for treating a substrate according to an exemplary embodiment of the present disclosure.

The exemplary embodiments of the present disclosure have been described hereinabove with reference to the accompanying drawings, but it will be understood by one of ordinary skill in the art to which the present disclosure pertains that various modifications and alterations may be made without departing from the technical spirit or essential feature of the present disclosure. Therefore, it is to be understood that the exemplary embodiments described above are illustrative rather than being restrictive in all aspects.

What is claimed is:

1. An apparatus for heating a chemical liquid, comprising:
a flow path provided as a path through which a chemical liquid used to treat a substrate passes;
a heating element disposed to surround at least a portion of the flow path; and
a light source irradiating the heating element with light,
wherein the heating element is heated using photon excitation, and heats the chemical liquid.

2. The apparatus for heating a chemical liquid of claim 1, further comprising a cover member covering the heating element.

3. The apparatus for heating a chemical liquid of claim 2, wherein the cover member transmits the light.

4. The apparatus for heating a chemical liquid of claim 3, wherein the cover member is made of quartz.

5. The apparatus for heating a chemical liquid of claim 1, wherein a temperature of the heating element rises to a predetermined temperature before the chemical liquid passes through the flow path.

6. The apparatus for heating a chemical liquid of claim 1, wherein the heating element is made of a material that does not react with the chemical liquid.

7. The apparatus for heating a chemical liquid of claim 6, wherein the heating element is made of single-crystal silicon.

8. The apparatus for heating a chemical liquid of claim 6, wherein the heating element is made of at least one of silicon (Si), silicon carbide (SiC), silicon dioxide (SiO₂), and aluminum nitride (A1N).

9. The apparatus for heating a chemical liquid of claim 1, wherein the heating element has any one of a cross shape and a ring shape in a width direction.

10. The apparatus for heating a chemical liquid of claim 1, further comprising a temperature sensor connected to an outlet of the flow path to measure a temperature of the chemical liquid,
wherein it is confirmed whether a temperature of the heating element has risen based on the measured temperature of the chemical liquid.

11. The apparatus for heating a chemical liquid of claim 1, wherein the light source includes at least one of a light emitting diode (LED) source or a laser diode (LD) source.

12. The apparatus for heating a chemical liquid of claim 1, further comprising a sidewall member disposed to surround the remaining portion of the flow path when the heating element is disposed to surround a portion of the flow path.

13. The apparatus for heating a chemical liquid of claim 12, wherein the sidewall member is made of a material that does not react with the chemical liquid.

14. An apparatus for heating a chemical liquid, comprising:
a flow path provided as a path through which a chemical liquid used to treat a substrate passes;
a heating element disposed to surround at least a portion of the flow path;
a light source irradiating the heating element with light; and
a cover member covering the heating element and transmitting the light,
wherein the heating element is heated using photon excitation, and heats the chemical liquid.

15. A system for treating a substrate, comprising:
an apparatus for storing a chemical liquid that stores the chemical liquid used to treat the substrate;
a jetting member jetting the chemical liquid onto the substrate to allow the substrate to be treated; and
an apparatus for heating a chemical liquid installed on a path through which the chemical liquid moves from the apparatus for storing a chemical liquid to the jetting member,
wherein the apparatus for heating a chemical liquid includes:
a flow path provided as a path through which the chemical liquid passes;
a heating element disposed to surround at least a portion of the flow path; and
a light source irradiating the heating element with light,
the heating element being heated using photon excitation, and heating the chemical liquid.

16. The system for treating a substrate of claim 15, wherein the apparatus for heating a chemical liquid further includes a cover member covering the heating element and transmitting the light.

17. The system for treating a substrate of claim 15, wherein a temperature of the heating element rises to a predetermined temperature before the chemical liquid passes through the flow path.

18. The system for treating a substrate of claim 15, wherein the heating element is made of a material that does not react with the chemical liquid.

19. The system for treating a substrate of claim 15, wherein the heating element has any one of a cross shape and a ring shape in a width direction.

20. The system for treating a substrate of claim 15, wherein the apparatus for heating a chemical liquid further includes a temperature sensor connected to an outlet of the flow path to measure a temperature of the chemical liquid, and
it is confirmed whether a temperature of the heating element has risen based on the measured temperature of the chemical liquid.
